(19) United States
(12) Patent Application Publication
(10) Pub. No.: US 2019/0378123 A1
(43) Pub. Date: Dec. 12, 2019

(54) ELECTRONIC SYSTEM FOR ARRANGING FOREIGN SERVICES

(71) Applicant: VISA INTERNATIONAL SERVICE ASSOCIATION, San Franciso, CA (US)

(72) Inventors: Geok Peng Chua, Foster City, CA (US); Lori Inouye, Foster City, CA (US); Dushyant Saran, San Francisco, CA (US); Sonal Singla, Foster City, CA (US); Georgianna Waters, Foster City, CA (US)

(21) Appl. No.: 16/487,773

(22) PCT Filed: Feb. 24, 2017
(86) PCT No.: PCT/US2017/019386

§ 371 Date: Aug. 21, 2019

(51) Int. Cl. G06Q 20/38; G06Q 20/14; G06Q 20/40

(52) U.S. Cl. CPC G06Q 20/381; G06Q 20/3821; G06Q 20/405; G06Q 20/14

(57) ABSTRACT

The disclosed system allows a foreign buyer to use a computer system to review services, select services and pay for services at pre-arranged prices.

### BACKGROUND

In some situations, it may be desirable to obtain or purchase services in a different country or a different geographic area. There are many common challenges as the purchaser is often not local and does not know the local area, the local prices, the local service providers and the local customs among other challenges. In the past, intermediaries have tried to assist people in arranging for services but the intermediaries are costly, having varying reputations and cannot negotiate deals or discounts in bulk.

### SUMMARY

The disclosed system allows a foreign buyer to use a computer system to review services, select services and pay for services at pre-arranged prices. The user may view and analyze a variety of service providers and may select a desired service provider which have been pre-arranged by the payment system. The system may determine the availability and location of the service provider and the pre-negotiated price of the service provider. The user may use an electronic payment system to pay for the service.

### BRIEF DESCRIPTION OF THE DRAWINGS

FIG. 1 is an illustration of a system

FIG. 2 is an illustration of method

FIG. 3 is a user interface (selection)

FIG. 4 may illustrate the selection of service features.

FIG. 5 may illustrate the ability to add weights to service features.

FIG. 6 may illustrate one embodiment of the possible outcomes being displayed to a user.

FIG. 7 may be an illustration of a user interface that illustrates the services selected.

FIG. 8 may be an illustration of a portable computer system and a server computer system;

FIG. 9 may be an illustration of a portable computing system; and

FIG. 10 may be an illustration of a sample server computing system with a database.

### SPECIFICATION

The present disclosure now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the example embodiments may take the form of an entirely hardware embodiment, an entirely software embodiment, or an embodiment combining software and hardware aspects. The following detailed description is, therefore, not to be taken in a limiting sense. The servers may be in a single server, a server with multiple processors or in processors that are remote but are in communication with each other. The processors may be physically configured as hardware or may be physically configured according to computer executable instructions which physically configure the processor to perform computer operations as described herein.

In some situations, it may be desirable to obtain or purchase services in a different country or a different geographic area. There are many common challenges as the purchaser is often not local and does not know the local area, the local prices, the local service providers and the local customs among other challenges. In the past, intermediaries have tried to assist people in arranging for services but the intermediaries are costly, having varying reputations and cannot negotiate deals or discounts in bulk.

The disclosed system allows a foreign buyer to use a computer system to review services, select services and pay for services at pre-arranged prices. The user may view and analyze a variety of service providers and may select a desired service provider which have been pre-arranged by the payment system. The system may determine the availability and location of the service provider and the pre-negotiated price of the service provider. The user may use an electronic payment system to pay for the service.

As an example, a user may desire medical services in a foreign country. The user may have no idea of who is a good doctor, where the doctor is located, where to stay when visiting the doctor, where to eat when visiting the doctor, how to arrange transportation to the doctor's office, how much the doctor will cost, etc. The present system may contact medical insurance companies and/or medical providers and arrange all the details for a medical visit, including reduced fees such as received by patients covered by local insurance. The details on the doctors, the visit time, the locations, the transportation options, the rental options, the doctor's success rate, the doctor's specialty, the doctors may all be predetermined and may be loaded into a database system. The patient may enter their relevant information such as the needed service, the timing at play, the length of the stay, the necessity of rental options, the need for transportation, and the budget for the services. The system may review the options and make a recommendation of a service provider, a time, a place to stay, transportation options, and a proposed cost. The system may also take care of payment for the various services.

As a result, many technical problems are addressed. First, trying to sift through service providers in a far-away place is not easy. The system does the work for the user. Similarly, trying to find locations to stay near service providers and which can assist in the service has been extremely difficult without local knowledge. By using the described system, logistical details may be pre-screened, may be loaded into a database and the details may be matched to the requirements of a user. Finally, the payment for the service may be pre-set or may be fixed fees such as when negotiating with an insurance company with set rates for services.

The transaction may occur in a variety of ways. In some embodiments, the payment device may be purchased from a group that interfaces with service providers such as a credit card issuer or an issuing bank. In other embodiments, a dedicated service provider may undertake the task of negotiating the various arrangements somewhat like a travel agent. In other embodiments, service providers may sell the service such as an insurance company or an educational aggregator. The system may be applied to many situations such as medical care, education, auto services, airplane services, boat services, travel tours, extreme travel, architectural consultations, IT consultation, or any other service consultation.

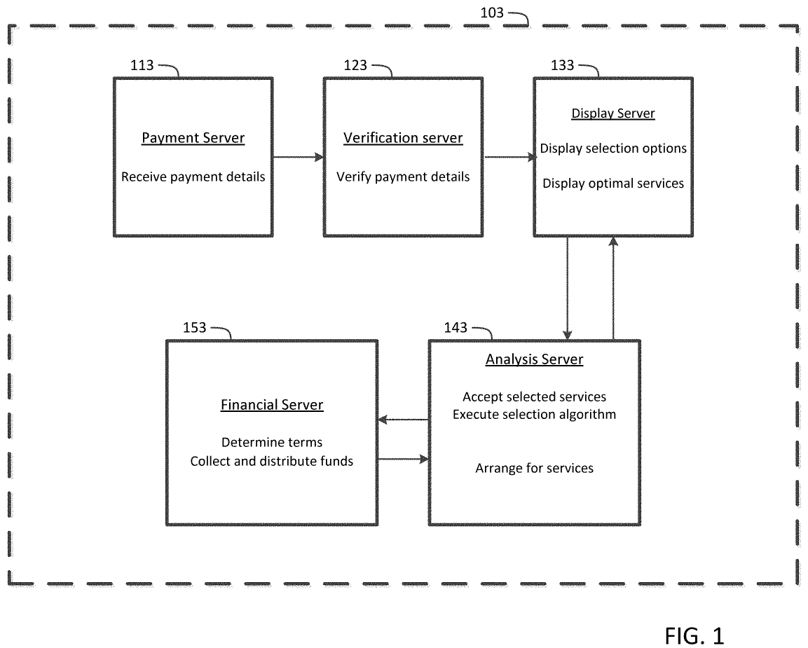

A variety of servers 104 may be used as part of the system as illustrated in FIG. 1. As mentioned previously, the servers 104 in the system 103 may be separate servers which may be purpose built to execute a function or series of functions. In other embodiments, the servers may exist in a single server where the server may have a single processor or a plurality of processors. The servers may be local or may be remote and the system may operate locally or may be a software as a service type application.

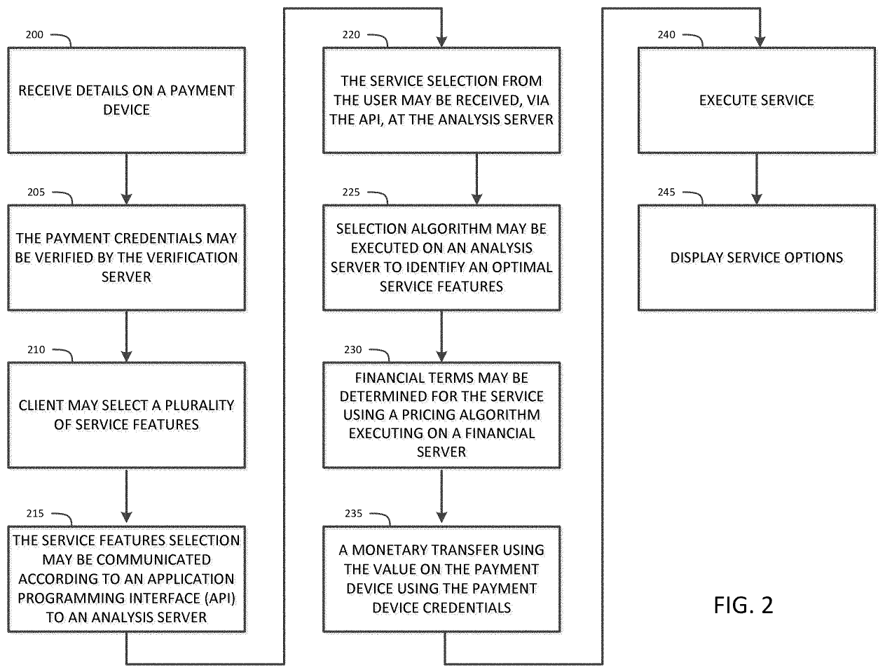

A payment server 113 may receive details on a payment device from a payment device provider as illustrated in the method of FIG. 2 at block 200. The payment device provider may work with a variety of service providers and the available service providers may depend on the payment service provider. For example, the payment device may be a credit card and the issuer may work with one or more medical insurance companies to secure discounts for users that are willing to use the credit card to pay for services. The credit card issuer may work with an insurance company to negotiate better rates for medical services which would not be available to foreigners and those rates may be passed on to consumers. Thus, in the future, the doctors and medical facilities that appear to a user may be those doctors that have already negotiated prices and services with the card issuer or related insurance company.

At block 205, the payment credentials may be verified by the verification server 123. For example, only some account numbers may be qualified for the system and the account numbers may be verified to ensure the payment account is part of the system. In addition, if the card issuer has paired up with an insurance company, only some service providers may be available. Thus some service providers may only be available depending on the account that was verified.

In response to the payment device credentials being verified by the verification server 123, at block 210, a computer executable link from the display server 133 may be displayed where a client may select a plurality of service features related to the service using the link using the display server 133. For example, if a user is seeking educational services, the service feature will be different than if a user is seeking medical treatment. The service features may related to the service selected. Some sample service features include a service provider from the plurality displayed providers, a current location, a desired location, a desired service time and the service receiver.

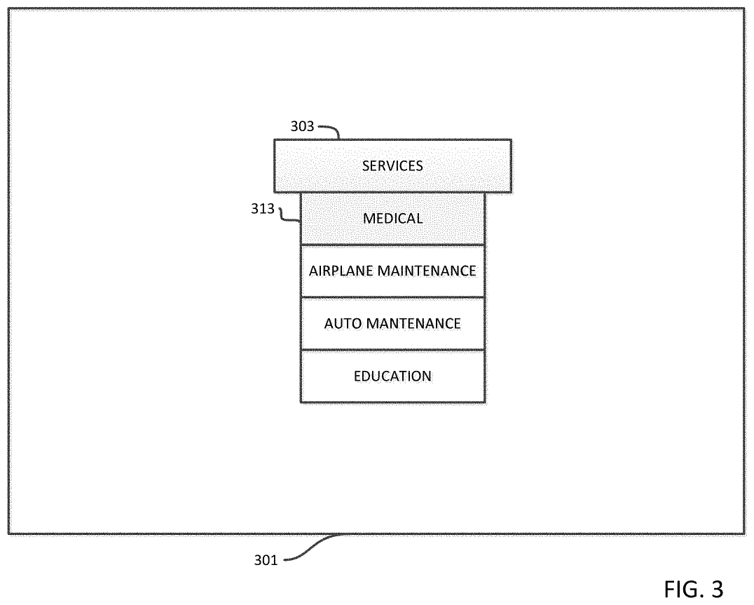

FIG. 3 may illustrate a sample user interface for selecting a service. The user interface 301 may allow a user to select a service from a plurality of available services 303. The displayed services may be only the services available based on the payment device purchased. For example, some payment devices may be intended only for education while other payment devices may be useful for multiple services. Only the available services for the specific payment device may be displayed. In other embodiments, additional services may be displayed but may be greyed out 313 which may indicate a different payment device may need to be used, such as a payment device with a bigger balance or a payment device that has additional service features.

At block 215, the service features selection may be communicated according to an application programming interface (API) to an analysis server 143. In some embodiments, weights may be added to each service selection to indicate a level of importance to a user. For example, if a service feature of the location is important, a larger weight 513 may be added to the location and the weight may be accommodated by the API.

A sample API may expect known fields of known sizes that contain data in a known type. As outsiders will know the details of the API, outsiders also will be able to format the data in the format as defined in the API. For example, a service provider may format data to be added to the system database in a known format that is expected by the API. Thus updates and changes may be easily communicated to the system and may be easily handled and provided to users with a minimum of review and handling by humans.

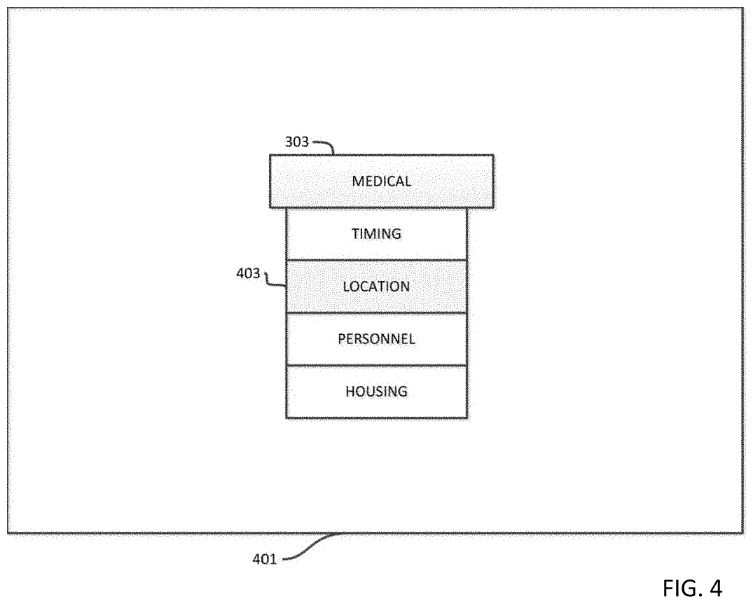

FIG. 4 may illustrate the selection of service features 403 in a user interface 401. The service features 403 may be specific to the service 303 selected. For example, if the service is for educational services, the service features may include what semester the user wanted to start, what major the user wanted to pursue, what campus to attend, what professors are desired, what dorm the user wants to live in, what roommates are desired, etc. while the service features for medical services may be different.

At block 220, the service selection from the user may be received, via the API, at the analysis server 143. The communication may be in a variety of forms such as wired communication, wireless communication, a combination of wired and wireless, etc. The communication may be encrypted or secured in an appropriate manner as medical information may be subject to heightened security concerns and requirements.

At block 225, in response to receiving the selections as part of the computer executable link, a selection algorithm may be executed on an analysis server 143 to identify an optimal service features such as the determined service provider, determined service location, determined service time. As previously stated, the determined service provider and determined service location may have a pre-existing financial arrangement with the payment device provider.

The algorithm may take on a variety of forms. At a minimum, the algorithm may attempt to meet the maximum number of service features. For example, if a desired doctor can be found on a desired date but the location is not a match, it still may match the most service features in comparison to other dates and times.

In another embodiment, the various service features may be given weights and the weights may factor into the algorithm. For example, if a specific doctor is given a heavy weight, the algorithm may be adjusted to take the heavier weight into account. Similarly, if the service procedure is needed quickly, the time of the service may be given a heavier weight and the algorithm may be adjusted to accommodate the heavier weight on the timing of the service.

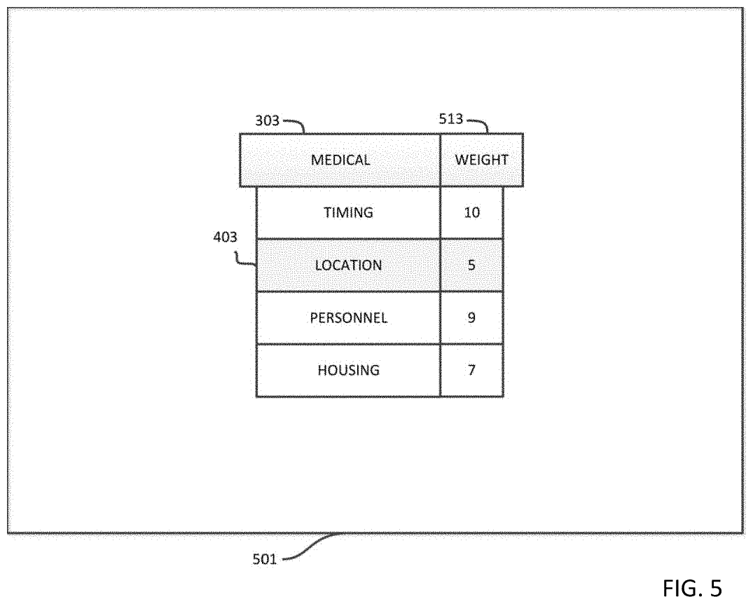

FIG. 5 may illustrate a user interface 501 that illustrates the ability to add weights to service features 403 for a service 303. As mentioned previously, the weights may indicate a priority level to the user and the algorithm may use the weights to best match the desires of the users.

Past services may be reviewed for positive and negative outcomes. The outcomes may be used to rank the various service provider and service locations. Thus, if a user has a strong desire for a positive service experience, the positive outcomes may be given greater importance by the algorithm.

The outcomes may be gathered in a variety of ways. In some embodiments, the outcomes may be simple binary outcomes such as was the surgery successful or not. In other embodiments, the outcomes may be given numerical values such as a value between 1-10 where 10 was a perfect outcome, 7 was an ok outcome, 5 was an average outcome, 3 was a below average outcome and 0 was death. Further, there may be a variety of dimensions to the outcomes. For example, a doctor may be judged on his/her bedside manner, pre-surgery instructions, surgery skills, post-surgery follow-up, and long term results. Each of these dimensions may be used as a way to separate the doctors and may be additional service factors that may be selectable by a user.

Similarly, there may be a plurality of dimensions that may be used to rank a service location such as the vicinity of lodging, the cleanliness of the location, the safety of the location, the wait times at the location, etc. Further, the dimensions may be service specific. For example, if desired service is education, the dimensions that may be reviewed may be different than the dimensions for auto service. Again, the various dimensions may also be used as service factors that may be selected by the users.

In some embodiments, the various combinations of options available may be scored based on how close the combinations match the requested service features. If the scores are over a threshold, the available options may be displayed to a user and the user may be able to select from the options. In another aspect, the user may be able to adjust the threshold and additional options may appear.

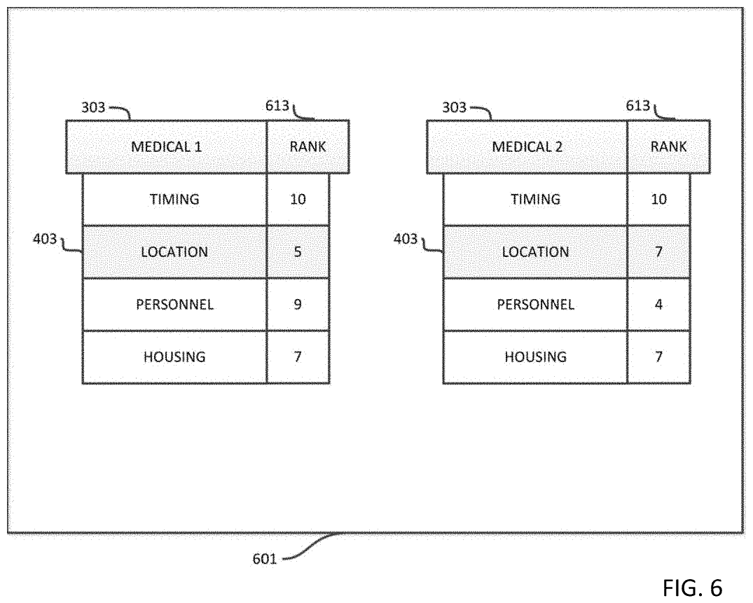

FIG. 6 may illustrate one embodiment of a user interface 601 of the possible outcomes being displayed to a user. Medical 1 may illustrate a first option and medical 2 may illustrate a second option. The rank 613 may note that the displayed service feature 403 may have been ranked by past users. For example, location 2 may have a higher ranking (7 vs 5 for Medical 1) while personnel in Medical 1 may have a higher ranking (9 vs 4 for Medical 2).

In addition, the algorithm may review past results and adjust the rankings for the services features. For example, a person that places a high value on location may value the input from other users that placed a high value on location. By reviewing the reviews from past users that valued location, the more recent users may benefit from the experiences of past users.

In some embodiments, the algorithm may be a learning algorithm where past algorithm decisions and results are used to better refine algorithmic decisions in the future. In operation, a set of training data may be identified. The training data may include review data, weighting data, services options, etc. and the training data may be split into sections. A first section may be used as test data and the other sets of data may be used to train the model. In an additional iteration, the test data may be added to the training data and another set from the original set of training data may be used to test the model. The process may continue until all the data sets have been used as test data sets.

At block 230, financial terms may be determined for the service using a pricing algorithm executing on a financial server 153. The financial server 153 may take into account the determined service provider, determined service location, determined service time, discount based on the payment device provider. As just one practical example, a card issuer may negotiate with a health insurance company such that purchasers of an account from the card issuer may have access to the health insurance company's roster of medical facilities, doctors and related discounts.

At block 235, executing on the server a monetary transfer using the value on the payment device using the payment device credentials. In some embodiments, the payment device value may be adjusted to match the cost of the desired service. For example, the purchase of a $20,000 payment account may be enough for medical services at a given level but if a higher level of service is desired, the value of the payment device may be increased through a transfer from another account. The amount may be used for one or more aspects of the service, such as paying for lodging, paying for medical services, paying for transportation, paying for meals, etc.

At block 240, arrange for the service and service selections to be executed using the analysis server 143. The service features have been held during the selection process. Once the service features have been selected, the analysis server may then arrange the service features to occur in the selected manner on the selected day. For example, a user may have to be transported from a home in a foreign country to an airport in that country, then the user may need tickets on an airline at a desired level of service, the user may need transportation from the remote airport to the selected lodging, etc. As the system may arrange and customize each feature of the services, the customization may be a significant technical challenge as each of the services factors have to dovetail with the next service feature.

As the service features are secured and the final details are finalized, a document may be created that explains the details of the service features selected as finalized. If there are any details that need to be adjusted or additional service features that have to be selected, those features may be noted. The finalized service may be communicated to the user at block 245.

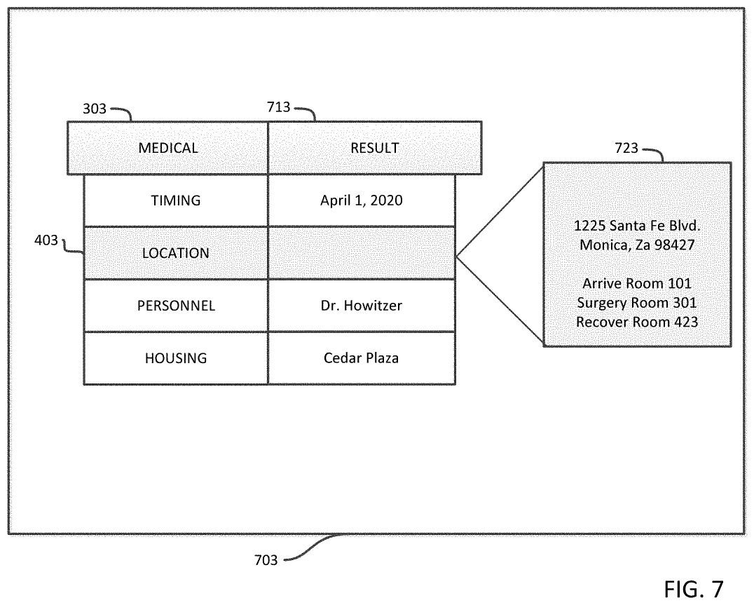

FIG. 7 may be an illustration of a user interface 703 that illustrates results 713 from the services selected. Logically, the service features 403 that are displayed may be specific to the service 303 selected as previously described. The result may provide a summary and additional details 723 about a service feature 403 may be obtained by selecting the service feature 403. Even further detail such as a map (not shown) may be obtained by selecting the additional details 723.

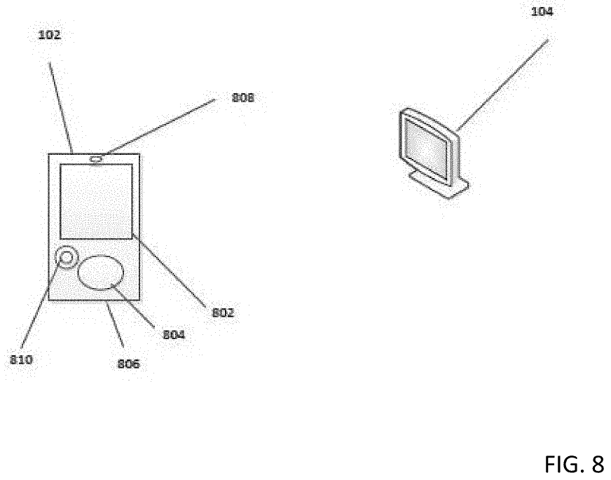

FIG. 8 may be a high level illustration of some of the elements a sample computing environment that may be physically configured to implement the various embodiments of the method and its logical variants. A user device 102 in the computing environment may store a software payment application that may be accessed in a variety of ways. There may be various versions of the application to take advantage of the benefits of different computing devices, different languages and different API platforms. In some embodiments, the entire system 103 may be accessed through a portable computing device 102 such as a smart phone and the desired activities directed toward clients may occur using a portable computing device 102.

The user device 102 may have a display 802 which may or may not be a touch sensitive display. More specifically, the display 802 may have a capacitance sensor, for example, that may be used to provide input data to the user device 102. In other embodiments, an input pad 804 such as arrows, scroll wheels, keyboards, etc., may be used to provide inputs to the user device 102. In addition, the user device 102 may have a microphone 806 which may accept and store verbal data, a camera 808 to accept images and a speaker 810 to communicate sounds.

The user device 102 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the server 104 or through a wireless network, e.g., Bluetooth, etc. FIG. 7 may be a simplified illustration of the physical elements that make up a user device 102 and FIG. 8 may be a simplified illustration of the physical elements that make up the server 104.

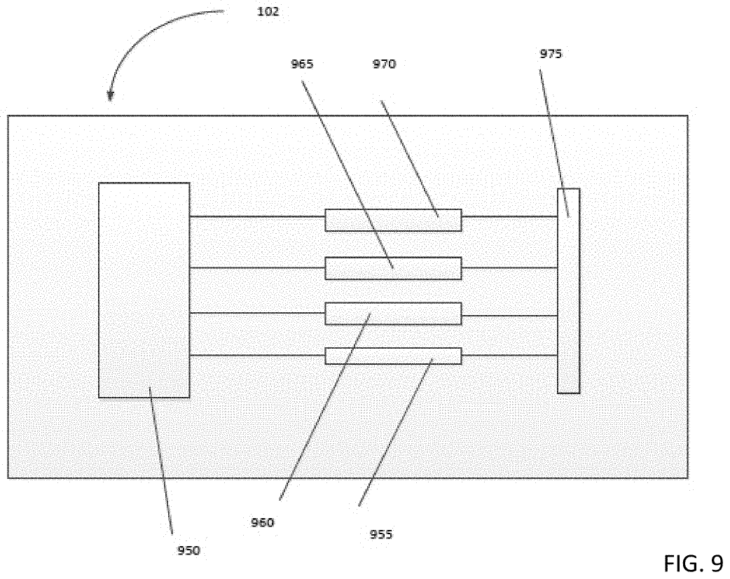

FIG. 9 may be a sample user device 102 that is physically configured according to be part of the system. The user device 102 may have a processor 950 that is physically configured according to computer executable instructions. It may have a portable power supply 955 such as a battery which may be rechargeable. It may also have a sound and video module 960 which assists in displaying video and sound and may turn off when not in use to conserve power and battery life. The user device 102 may also have volatile memory 965 and non-volatile memory 970. There also may be an input/output bus 975 that shuttles data to and from the various user input devices such as the microphone 906, the camera 908 and other inputs 902, etc. It also may control of communicating with the networks, either through wireless or wired devices. Of course, this is just one embodiment of the portable computing device 102 and the number and types of portable computing devices 102 is limited only by the imagination.

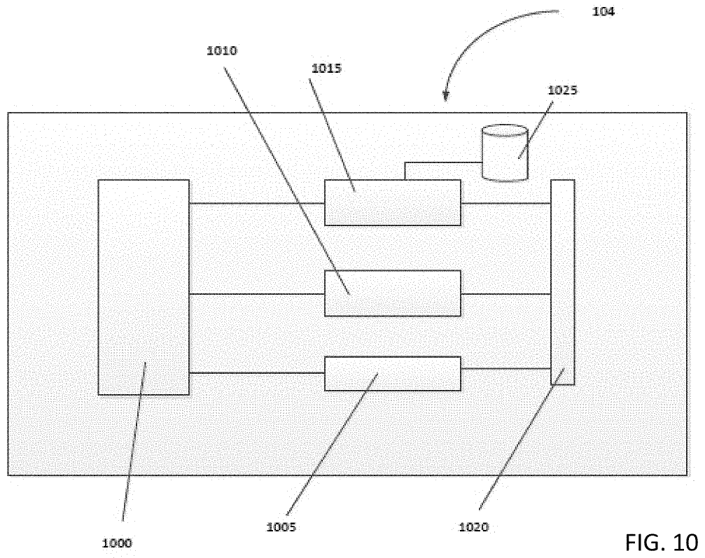

An example of the physical elements that make up a server 104 such as the payment server 113, verification server 123, display server 133, analysis server 143 and financial server 153 may be further illustrated in FIG. 10. Some of the physical elements may be located in other devices, depending on processing needs. The server 104 may have a processor 1000 that is physically configured according to computer executable instructions. It may also have a sound and video module 1005 which assists in displaying video and sound and may turn off when not in use to conserve power and battery life. The server 104 may also have volatile memory 1010 and non-volatile memory 1015. And as mentioned previously, each server may be physically built to meet the specific identified task.

In some examples, the server 104 may include a digital storage such as a magnetic disk, an optical disk, flash storage, non-volatile storage, etc. Structured data may be stored in the digital storage such as in a database. A database 1025 may be stored in the memory 1010 or 1015 or may be separate. The database 1025 may also be part of a cloud and may be stored in a distributed manner. There also may be an input/output bus 1020 that shuttles data to and from the various user input devices such as the microphone 806, the camera 808, the inputs 802, etc. The input/output bus 1020 also may control of communicating with the networks, either through wireless or wired devices. Of course, this is just one embodiment of the server 104 and the number and types of user devices 102 is limited only by the imagination.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

The user devices, terminals, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, terminals, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, terminals, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, terminals, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving data transfer. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A payment system for foreign service payments using a payment device from a payment device provider comprising :
a server for receiving payment device credentials;
in response to the payment device credentials being verified by the server;
providing a computer executable link via the server wherein a client may select a plurality of service features using the computer executable link wherein the service features comprise at least one from a group comprising:
a service from a plurality displayed services;
a current location;
a desired location;
a desired service time;
a service provider;
wherein selected features of the computer executable link are communicated according to an application programming interface (API);
receiving, via the API, the selected features at the server;
in response to receiving the selected features as part of the computer executable link, executing a selection algorithm on a selection server to identify an optimal:
determined service provider;
determined service location;
determined service time;
wherein the determined service provider and determined service location have a pre-existing financial arrangement with the payment device provider;
determining financial terms for the service using a pricing algorithm executing on a financial server in view of the:
determined service provider,
determined service location,
determined service time,
discount based on the payment device provider; and
executing on the server a monetary transfer using a value on the payment device using the payment device credentials.

2. The payment system of claim 1, wherein optimal service features compares scored service features to threshold for the service features and creates a group of service features which scored over the threshold.

3. The payment system of claim 1, further comprising presenting a plurality of options and prices.

4. The payment system of claim 1, further comprising allowing priority weights to be added to a service provider, a service location or a service time.

5. The payment system of claim 1, wherein payment device credential comprise a payment account, a payment account sponsor and a payment account expiration date.

6. The payment system of claim 1, wherein the payment device is purchased electronically.

7. The payment system of claim 1, wherein the payment device is purchased from a group that interfaces with service providers.

8. A user interface for a payment system for foreign service payments using a payment device from a payment device provider comprising:
a user interface for receiving payment device credentials;
in response to the payment device credentials being verified by a payment server;
providing a computer generated display that includes an executable link wherein the user interface displays a plurality of service features available using the executable link wherein the service features comprise at least one from a group comprising:
a service from a plurality displayed services;
a current location
a desired location;
a desired service time;
a service provider;
wherein selections of the executable link are communicated according to an API;
receiving, via the API, the selections at the payment server;
in response to receiving the selections as part of the executable link, executing a selection algorithm on the payment server to identify an optimal:
determined service provider;
determined service location;
determined service time;
displaying in the user interface the optimal:
determined service provider;
determined service location;
determined service time;
wherein the determined service provider and determined service location have a pre-existing financial arrangement with the payment device provider;
determining financial terms for the service using a pricing algorithm executing on the payment server in view of the:
determined service provider,
determined service location,
determined service time,
discount based on the payment device provider;
displaying the determined financial terms for the service in the user interface;
executing on the payment server a monetary transfer using a value on the payment device using the payment device credentials; and
displaying details of the monetary transfer on the user interface.

9. The user interface of claim 8, wherein optimal service features compares scored service features to threshold for the service features and creates a group of service features which scored over the threshold.

10. The user interface of claim 8, further comprising presenting a plurality of options and prices.

11. The user interface of claim 8, further comprising allowing priority weights to be added to a service provider, a service location or a service time.

12. The user interface of claim 8, wherein payment device credential comprise a payment account, a payment account sponsor and a payment account expiration date.

13. The user interface of claim 8, wherein the payment device is purchased electronically.

14. The user interface of claim 8, wherein the payment device is purchased from a group that interfaces with service providers.

15. A method for foreign service payments using a payment device from a payment device provider comprising :
receiving payment device credentials in a user interface provided by a server;
in response to the payment device credentials being verified by the server;
providing an executable link via the server wherein a client may select a plurality of selections using the executable link wherein the selections comprise at least one from a group comprising:
a service from a plurality displayed services;
a current location;
a desired location;
a desired service time;
a desired service provider;
wherein selections of the executable link are communicated according to an application programming interface (API);
receiving, via the API, the selections at the server;
in response to receiving the selections as part of the executable link, executing a selection algorithm on the server to identify an optimal:
determined service provider;
determined service location;
determined service time;
wherein the determined service provider and determined service location have a pre-existing financial arrangement with the payment device provider;
determining financial terms for the service using a pricing algorithm executing on the server in view of the:
determined service provider,
determined service location,
determined service time,
discount based on the payment device provider; and
executing on the server a monetary transfer using a value on the payment device using the payment device credentials.

16. The method of claim 15, wherein optimal service features compares scored service features to threshold for the service features and creates a group of service features which scored over the threshold.

17. The method of claim 15, further comprising presenting a plurality of options and prices.

18. The method of claim 15, further comprising allowing priority weights to be added to a service provider, a service location or a service time.

19. The method of claim 15, wherein payment device credential comprise a payment account, a payment account sponsor and a payment account expiration date.

20. The method of claim 15, wherein the payment device is purchased from a group that interfaces with service providers.
